(19) United States
(12) Patent Application Publication
(10) Pub. No.: US 2023/0052850 A1
(43) Pub. Date: Feb. 16, 2023

(54) SOLID OXIDE CELL ASSEMBLY

(71) Applicant: Sunfire GmbH, Dresden (DE)

(72) Inventors: Danilo Schimanke, Dresden (DE); Peter Meisel, Dresden (DE)

(73) Assignee: Sunfire GmbH, Dresden (DE)

(21) Appl. No.: 17/783,983

(22) PCT Filed: Dec. 9, 2020
(86) PCT No.: PCT/DE2020/101043

§ 371 Date: Jun. 9, 2022

(30) Foreign Application Priority Data
Dec. 10, 2019 (EP) 19214778.3

(51) Int. Cl. H01M 8/04007; H01M 8/1246; H01M 8/2432; H01M 8/249; H01M 16/00

(52) U.S. Cl. CPC H01M 8/04074; H01M 8/249; H01M 8/1246; H01M 8/2432; H01M 16/003; H01M 2008/1293

(57) ABSTRACT

A solid oxide cell assembly includes a housing that further includes a base plate, a cover and one or more side walls. one or more solid oxide cell stacks are positioned on the base plate. at least one radiant heater element is positioned inside the housing and is configured to emit radiant heat onto the one or more solid oxide cell stacks. the at least one radiant heater element is formed as one of a heating tube and a heating plate and comprises a plurality of separately controllable segments each comprising separate power connections. The solid oxide cell assembly is further formed as a high temperature electrolysis cell assembly.

### CROSS REFERENCE TO RELATED INVENTION

This application is a national stage application pursuant to 35 U.S.C. §371 of International Application No. PCT/DE2020/101043, filed on Dec. 9, 2020, which claims priority to, and benefit of, European Pat. Application No. 19214778.3, filed Dec. 10, 2019, the entire contents of which are hereby incorporated by reference.

### TECHNOLOGICAL FIELD

The disclosure relates to a solid oxide cell arrangement or assembly having a housing, wherein the housing comprises a base plate, a cover, and side walls, and solid oxide cell stacks, wherein the solid oxide cell stacks are located on the base plate.

### BACKGROUND

In the use of high temperature fuel cell arrangements, various liquid and gaseous hydrocarbon-based fuels (natural gas, LPG) are converted into power and heat. In high temperature electrolysis cell arrangements, electrical energy is converted into chemical energy.

A solid oxide cell arrangement contains at least a solid oxide cell stack as central unit, wherein during use as a high temperature fuel cell arrangement, gaseous hydrocarbon-based fuel or hydrogen supplied at an H2 electrode side of the solid oxide cell stack is converted with air supplied at an O2 electrode side; during use as a high temperature electrolysis cell arrangement, steam and/or carbon dioxide supplied at an H2 electrode side of the solid oxide cell stack are converted into oxygen and hydrogen or carbon monoxide. Solid oxide cell arrangements (SOC) can comprise both high temperature fuel cell arrangements (SOFC) as well as high temperature electrolysis cell arrangements (SOEC).

The operating temperature of solid oxide cell arrangements is usually at temperatures of 700 to 900° C., depending on the materials. When heating up from room temperature, heat must be transported into the solid oxide cell stack via lines, convection or radiation. Different arrangements are known in the prior art for operating solid oxide fuel cells.

In the high temperature fuel cell arrangements, the cell stacks can be arranged both in rows, as well as annular or respectively circular shaped.

A linear arrangement is known for example from document WO 2017/191353 A1, from which a stack arrangement of a high temperature fuel cell system or electrolysis cell system is disclosed, wherein each cell in the cell system comprises an H2 electrode side, an O2 electrode side, and an electrolyte disposed therebetween, wherein the cell system comprises the cells in cell stacks. The arrangement comprises the stack arranged in row arrangement, wherein the stacks are arranged at least in two rows adjacent to one another, and the arrangement comprises air introduction channels for supplying air to the stacks, wherein the channels have air introduction ends that are conveyed to a sealed air introduction space that is formed between the stack rows with at least two sides of the air introduction space that is enclosed by the stacks themselves.

Cell stacks in a radial arrangement are known from US 7,659,022 B2, WO 2015/118208 A1 and DE 42 17 892 C2.

US 7,659,022 B2 describes an integrated fuel cell unit, wherein this contains an annular arrangement of fuel cell stacks, an annular cathode recuperator, an annular anode recuperator, a reformer, and an anode exhaust gas cooler, all of which are integrated into a shared housing structure.

WO 2015/118208 A1 discloses an assembly arrangement of solid oxide cells in a fuel cell system or in an electrolysis cell system. The assembly comprises the cells, which are arranged at least up to four angled at least one cell stack formation, and at least one essentially flat fixing side of each at least four angled stack formation, wherein the side comprises at least one geometrically differing fixing area structure in the otherwise essentially flat side between at least two corners of the at least four angled stack formation. The assembly arrangement further comprises at least one flow limitation structure for limiting air flows in the cell system to be assembled against the geometrically differing fixing surface structure of each stack formation for fixing at least one cell stack formation in the assembly arrangement, and an electrical insulation that is arranged for fixing the flow limitation structure and the stack formation.

DE 42 17 892 C2 describes an energy generation unit comprising an energy supply module with a heat-insulating container that is internally subdivided to provide a stack chamber, a combustion chamber, and a heat exchanger chamber. The stack chamber contains at least one fuel cell stack. The individual cells are supplied accordingly, wherein the supplied media are respectively warmed via the heat exchanger in the heat exchanger chamber. The direct voltage supplied by the fuel cells is converted into alternating current via a current regulator having a control device that regulates the entire generation of the energy supply module.

Process engineering components, such as electric gas pre-heaters or heat exchangers are positioned at the cell stack arrangements for temperature regulation. The heat transfer takes place by convection or thermal conduction.

A heater arrangement for a fuel cell device consisting of a radiant heater and a convection heater became known from WO 2012/131163 A1, where the radiant heater is provided outside of a fuel cell arrangement, and the convection heater is provided inside the fuel cell arrangement. The combination of types of heating is intended to enable even heat distribution as well as rapid heat-up, while avoiding thermal stress.

A fuel cell system comprising at least one electrical resistance heating element became known from US 2007/119638 A1. In this context, a plurality of resistance heating elements can be distributed so as to produce even heat distribution.

A fuel cell system comprising a cell stack became known from EP 1 271 684 A2, wherein the individual cells of the cell stack comprise an interconnect that is in thermal contact with the electrochemical part of the cells, via which interconnect heat can be supplied to the electrochemical part of the cells.

The problems in the prior art are essentially that temperatures of 700 to 900° C. (currently usual in the prior art) are usually necessary for operating the solid oxide cell arrangement. In this context, for solid oxide fuel cell applications (SOFC), heating up is accomplished either via electric pre-heaters or by means of chemical energy via afterburners with heat conductors disposed downstream therefrom, and for solid oxide electrolysis cell arrangements (SOEC and rSOC), via electric pre-heaters.

The media are heated up by convection via electrical pre-heaters, and in turn, these hot gases warm the solid oxide cell stack. Heating up by moved fluid necessarily results in heat losses, even if optimal heat recovery is achieved. The escaping gases always have a higher temperature than upon entry into the respective balance area. As a result, for example, an unnecessarily large amount of energy is used during heating up.

Moreover, in certain atmospheres, usually those containing steam, and in the high temperature range, some materials in electric pre-heaters can emit contaminants that negatively affect the performance of the solid oxide cell arrangements.

Electric pre-heaters are also relatively expensive assemblies. Moreover, they are integrated between the cell stacks and heat conductors, and thereby extend the pipe lines, which causes heat losses to increase.

Due to the higher media temperature, the pipe lines must be dimensioned larger. Furthermore, there are larger regions at high temperatures in the power unit, through which other functions are negatively affected, e.g. galvanic separation, sensors, power connections, and in some design variants, heat losses are higher. For example, the heat losses are increased when hot gases are guided along exterior walls.

Moreover, good accessibility to the individual components for upkeep, such as performing maintenance, is often not provided.

### BRIEF SUMMARY OF THE INVENTION

The object of the present invention is to provide an arrangement for efficiently heating up and operating high temperature solid oxide cell arrangements.

The complexity and number of components of an assembly essentially determines the costs. In applications with few cold-starts per year, an elaborate infrastructure for heating up should be avoided as much as possible. Both solid oxide cell stacks as well as media flows on the H2 and O2 side are to be heated up to the necessary temperature ranges using, if possible, only one heat-generating assembly.

The solid oxide cell arrangement is formed with a housing, solid oxide cell stacks, and at least one radiant heater element within the housing, via which radiant heater element radiant heat is transferred to the solid oxide cell stack. Due to this, electric pre-heaters are no longer necessary for warming the solid oxide cell stack. The imposed convection for heating up can therefore be dispensed with, and heating up is significantly more efficient. Up to 90% of the electrical energy invested for increasing the temperature of the cell stack is used efficiently, instead of previously only around 40%. This results in energy savings of at least 50% of the invested electrical energy (kWh) during heating up. Moreover, the heat losses are significantly lower since there are significantly less escaping gases with a higher temperature than the environment.

Since the radiant heater element is formed as a heating tube or heating plate, wherein this can be fixed to hang from above and/or on side walls, and/or standing on the base plate or integrated in ceramic plates, it is possible to form and mount the radiant heater element in a manner tailored to the individual case so that an optimal result, i.e. efficient heating up, is enabled. Moreover, this makes straightforward maintenance possible. If the radiant heater elements are integrated in a side wall, for example, access to both the radiant heater elements as well as to the solid oxide cell stacks is provided by removing or folding away the side wall.

Since the radiant heater element consists of a plurality of segments that can be separately regulated with separate power connections for the respective radiant heater segments, it is possible to prevent thermal imbalances by influencing the temperature locally. The basis for this approach is the physical relationship according to which the internal resistance of the ceramic cells falls at higher temperatures. Additionally, the law applies that the electrical power loss (= waste heat) is influenced quadratically by the power density and linearly by the internal resistance (P_{Loss} = RI²). Moreover, in electrical circuits wired in parallel, it is true that higher current intensities exist in branches with lower internal resistance. Based on these relationships, for example, both individual solid oxide cell series circuits of an electrical network can be positively influenced according to demand/type of operation (by means of radiant heater elements) as well as parts of a solid oxide series circuit (by means of radiant heater segments). It should be mentioned by way of limitation that the prevailing material behavior (degradation) cannot be changed by thermal influence, but its symptoms can be significantly mitigated.

Each solid oxide cell stack series circuit is globally controllable in terms of power density and switching-in of the associated radiant heater.

A locally controllable solid oxide cell stack series circuit can be enhanced by a locally different heat input. To this end, the entire heat conductor can be subdivided into segments, and each segment receives a power connection, whereby the performance of the solid oxide stack can be augmented. It should be mentioned that a series circuit is fundamentally limited by “the weakest link”. For example, if in SOEC operation one region is subject to higher heat losses, the voltage there increases up to the permissible maximum value. The current intensity is limited for the entire series circuit, and therefore the H2 production is as well. The hotter regions are not optimally exploited. With a segmented heater, the cooler regions can be subsequently heated in a targeted manner, and in this way the temperature of the solid oxide cell stack can be homogenized. The current intensity, or H2 production, respectively, can be increased since the cold cells no longer impose a limitation.

In SOFC operation, cells with higher internal resistance can increase the cooling demand to such an extent that the other cells cool down too much, and therefore the current intensity and electrical power are limited. These regions can be subsequently heated locally. In this context, it must be noted that this only makes sense energetically if the regions to be heated account for a small proportion of the entire solid oxide cell stack arrangement, and with the additional investment of electrical energy, significantly more electrical energy can be generated at the fuel cells, for example.

Since the solid oxide cell stacks can be provided in a plurality of rows adjacent to one another as a solid oxide cell stack series circuit, wherein each solid oxide cell stack can be assigned a radiant heater element, the efficiency of heating up the solid oxide stack is further improved. In this manner, the solid oxide cell stacks can be heated up over their entire area via the radiant heater elements. The heat given off by the radiant heater elements is distributed evenly since each solid oxide cell stack is heated up via the radiant heater element, and there are no unheated segments. This additionally contributes to an extended service life.

If in addition to the radiant heater elements, heat transferors for the media supply are disposed in the housing or outside on the flanges, the process heat is kept in the system. The heat of the escaping gases is optimally used for pre-warming the incoming gases. This results in an increase of the system efficiency. The previously used electric pre-heaters can be dispensed with. At least two heat transferrers, one each for the O2 and H2 electrode side, are required. The use of the enthalpy flows of the escaping gases is therefore of special importance for the profitability of a system.

Therefore, in some application cases, it makes sense to integrate more than two heat transferors. In light of use-dependent design, there are various possibilities. These comprise, for example: heat transferor with the same medium on two heat transferor sides, or as a mixture of the H2 and O2 side; decentral arrangement of many small heat transferors, or the central arrangement of large heat transferors; and a plurality of heat transferors in parallel circuit or series circuit.

In this connection, the combination of heat transferors with radiant heater elements is relevant. A plurality of variants can be derived from the above possibilities. These are, for example: heat transferor on the H2 side positioned directly below the individual towers of the cell stack series circuit (decentral arrangement on the H2 side); the media stream on the O2 side is cooled in two stages, first by means of a heat transferor on the O2 side, and then by means of a heat transferor on the H2 side; the media stream on the O2 side is split up, so that one part of the mass flow pre-warms the H2 side and another pre-warms the O2 side; media is supplied to the O2 side by the solid oxide cell stack side facing toward the heater; and media is supplied to the O2 side via separate metallic or metal-ceramic assemblies in the base support.

### BRIEF DESCRIPTION OF THE DRAWINGS

In the following, exemplary embodiments of the invention are described in detail, with reference to the drawings enclosed in the description of figures, wherein these are intended to explain the invention and are not to be interpreted as limiting. In the figures:

FIG. 1 schematically depicts a top down view of an embodiment of a solid oxide cell arrangement having a solid oxide cell stack and a lateral radiant heater element;

FIG. 2 schematically depicts a top down view of an embodiment of a solid oxide cell arrangement having two solid oxide cell stacks and two lateral radiant heater elements;

FIG. 3 schematically depicts a top down view of an embodiment of a solid oxide cell arrangement having two solid oxide cell stacks and three lateral as well as central radiant heater elements;

FIG. 4 schematically depicts a top down view of an embodiment of a solid oxide cell arrangement having three solid oxide cell stacks and three lateral as well as central radiant heater elements;

FIG. 5 schematically depicts s top down view of an embodiment of a solid oxide cell arrangement having four solid oxide cell stacks with throughflow of two cell stacks each, and two lateral radiant heater elements;

FIG. 6 illustrates a process diagram of an embodiment of a solid oxide cell arrangement having a solid oxide cell stack and a radiant heater element in combination with two heat transferors;

FIG. 7 illustrates a process diagram of another embodiment of a solid oxide cell arrangement having a solid oxide cell stack and a radiant heater element in combination with two heat transferors;

FIG. 8 illustrates a process diagram of an embodiment of a solid oxide cell arrangement having a solid oxide cell stack, a radiant heater element in combination with two heat transferors, and an additional convective, electric gas heater on the H2 media side;

FIG. 9 illustrates a process diagram of an embodiment of a solid oxide cell arrangement having a solid oxide cell stack and a radiant heater element in combination with three heat transferors;

FIG. 10 illustrates a process diagram of an embodiment of a solid oxide cell arrangement having a solid oxide cell stack and a radiant heater element in combination with three heat transferors and a divided exhaust air stream;

FIG. 11a illustrates a process diagram of an embodiment of a solid oxide cell arrangement with a radiant heater element, heat transferors arranged centrally in the gas processing unit, and an electric pre-heater;

FIG. 11b illustrates a process diagram of an embodiment of a solid oxide cell arrangement with only conventional, electric pre-heaters and heat transferors arranged centrally in the gas processing unit;

FIG. 12a illustrates a process diagram of an embodiment of a solid oxide cell arrangement with two separate radiant heater elements heat transferors arranged decentrally in the cell stack module and an electric pre-heater;

FIG. 12b illustrates a process diagram of an embodiment of a solid oxide cell arrangement with only conventional, electric pre-heaters and heat transferors arranged decentrally in the cell stack module; and

FIG. 13 schematically depicts a top down view of an embodiment of a solid oxide cell arrangement having a solid oxide cell stack and a lateral radiant heater element divided into radiant heater segments.

Functionally equivalent components are labeled with the same reference signs in the following description of the figures.

### DETAILED DESCRIPTION OF THE INVENTION

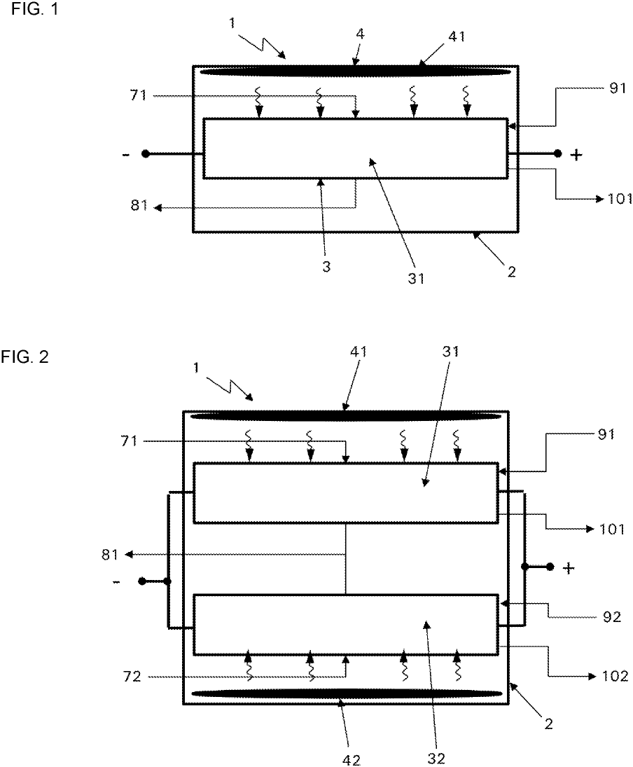

FIG. 1 shows a solid oxide cell arrangement or assembly 1 in a housing 2. The solid oxide cell arrangement 1 consists of a solid oxide cell stack 31 having a radiant heater element 41 mounted laterally on the housing 2.

The radiant heater element 41 that is mounted laterally on the housing 2 serves for heating up the solid oxide cell stack 31. The lateral mounting provides good access to the solid oxide cell stack 31 and/or to the radiant heater element 41. The radiant heater element 41 can be formed as a heating tube or heating plate, wherein this is fixed to hang from above and/or on side walls and/or stands on the base plate or can be integrated in ceramic plates.

Air enters the solid oxide cell stack 31 via the media supply on the O2 electrode side 71. The consumed air is led away via the media discharge on the O2 electrode side 81. The combustion gas is fed to the H2 electrode side 91 via the media supply. Excess combustion gas and water are led away via the media discharge on the H2 electrode side 101.

In FIG. 2 , two solid oxide cell stacks 31, 32 are provided as solid oxide cell stack series circuit. Two laterally mounted radiant heater elements 41, 42 are used, respectively. There is one media supply per cell stack 31, 32 on each of the O2 electrode side 71, 72 and the H2 electrode side 91, 92. The media discharge on the O2 electrode side 81 takes place in a stream; the media discharge on the H2 electrode side 101, 102 takes place separately, respectively.

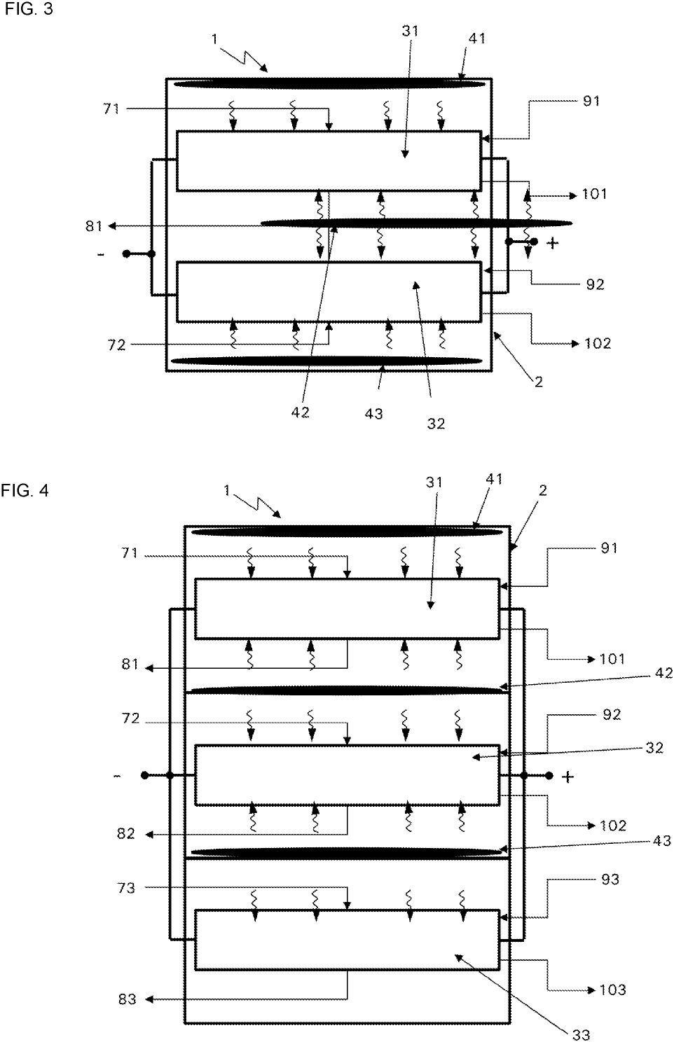

FIG. 3 differs from FIG. 2 in that aside from the two laterally mounted radiant heater elements 41, 43, there is also a centrally mounted radiant heater element 42.

In FIG. 4, three solid oxide cell stacks 31, 32, 33 are wired together. A radiant heater element 41 and two centrally-installed radiant heater elements 42, 43 are mounted laterally on the housing 2. Media supply and discharge take place separately per cell stack.

In FIG. 5, flow takes place through two cell stacks 3 jointly. The cell stacks 31, 32 as well as the cell stacks 33, 34 respectively have a media supply on the O2 electrode side 71, 72 and a shared media discharge on the O2 electrode side 81. The media supply and discharge on the H2 electrode side take place separately per cell stack, respectively. There are two laterally mounted radiant heater elements 41, 42.

As described in the above exemplary embodiments on the arrangement of radiant heater elements 4 in solid oxide cell arrangements 1, one radiant heater element 4 can be assigned to each solid oxide cell stack 3. In such a case, individual radiant heater elements 4 can be installed either centrally on solid oxide cell stacks 3 between the individual rows and/or mounted laterally, as previously described. The solid oxide cell stacks 3 can be heated up across their entire area in this manner via the radiant heater elements 4. Since the radiant heater elements 4 can consist of a plurality of separately controllable segments with separate power connections for the respective radiant heater segments, thermal imbalances can be avoided.

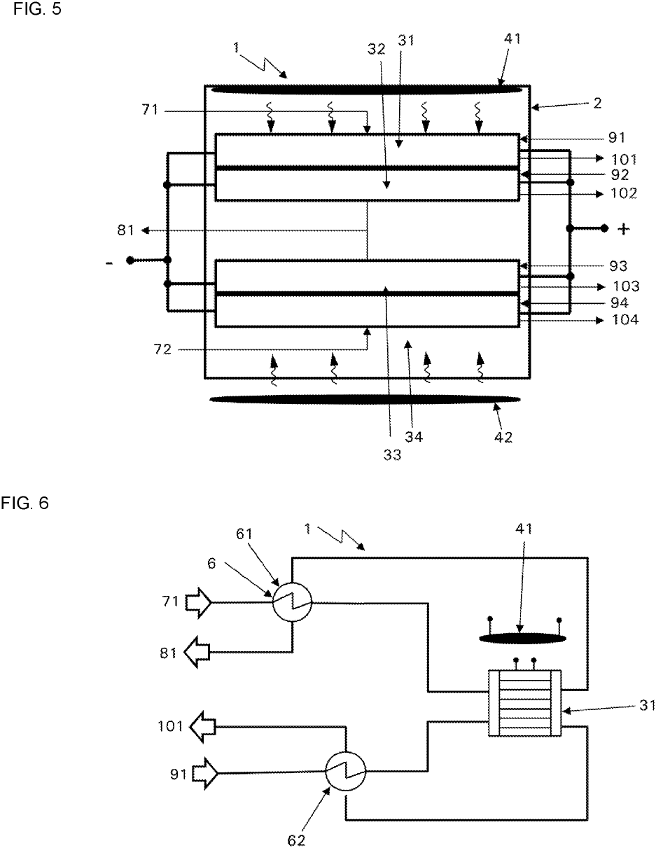

Process diagrams of a solid oxide cell arrangement 1 are shown in FIGS. 6 - 10. Various possibilities for combining radiant heater elements 4 with heat exchangers 6 are highlighted in the process diagrams.

In FIG. 6, a radiant heater element 41 is combined with two heat transferors 61, 62 in a solid oxide cell arrangement 1. A solid oxide cell stack 31 is warmed via the radiant heater element 41. Heat transferors are installed on the O2 electrode side 61 and a heat transferor is installed on the H2 electrode side 62. Air enters the solid oxide cell stack 31 via the media supply on the O2 electrode side 71. The consumed air is led away via the media discharge on the O2 electrode side 81. The combustion gas is fed to the H2 electrode side 91 via the media supply. Excess combustion gas and water are led away via the media discharge on the H2 electrode side 101.

With the heat transferors on the O2 electrode side 61, the media supply on the O2 electrode side 71 is warmed via the media discharge on the O2 electrode side 81. Accordingly, with the heat transferor on the H2 electrode side 62, the media supply on the H2 electrode side 91 warmed via the media discharge on the H2 electrode side 101. This increases the system efficiency.

The heat transferors 61, 62 can be mounted either directly in the housing 2 below the solid oxide cell stack 31, or laterally flanged onto the inlets and outlets of the housing 2. Heat losses are minimized by accommodating the heat transferors 61, 62 directly in the housing 2. The pipe lines are as short as possible and all elements are accommodated in the housing 2, which is thermally insulated, in an assembly.

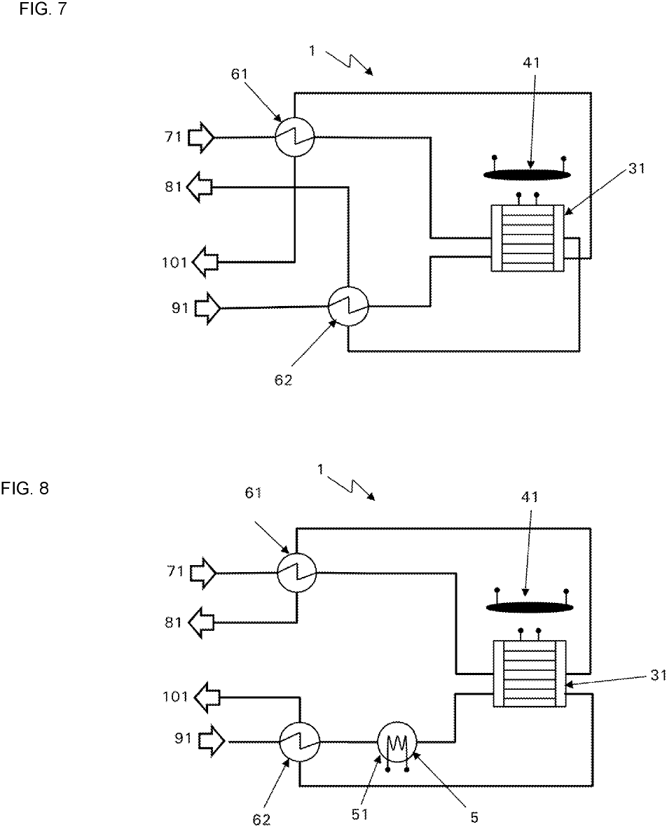

In FIG. 7, as in FIG. 6, a radiant heater element 41 is combined with two heat transferors 61, 62 in a solid oxide cell arrangement 1. A solid oxide cell stack 31 is warmed via the radiant heater element 41. Solely the media flow guidance is varied by the heat transferors 61, 62.

In FIG. 8 there is a solid oxide cell arrangement 1, wherein an additional convective, electric gas heater 51 was installed on the side of the media supply on the H2 electrode side 91.

The installation of such a convective, electric gas heater 5 is possible in all variants of the combination of radiant heater elements 4 with heat transferors 3, but should no longer be strictly necessary according to the novel solid oxide cell arrangement 1.

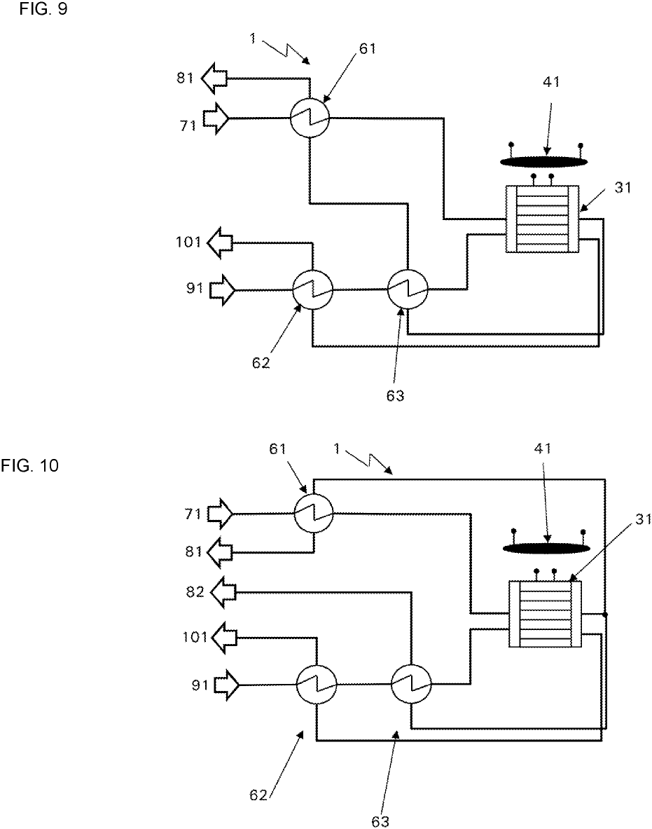

In FIG. 9, a radiant heater element 41 is combined with three heat transferors 61, 62, 63. The media discharge of the O2 electrode side 81 flows through two heat transferors 61, 62, and therefore heats both the media supply on the O2 electrode side 71 as well as the media supply on the H2 electrode side 91.

In FIG. 10, as in FIG. 9, a radiant heater element 41 is combined with three heat transferors 61, 62, 63. The O2 exhaust air flow, which is guided out of the solid oxide cell stack 31 has been additionally split into two sub-flows.

A plurality of additional variants is possible with the combination of radiant heater elements 4 with heat transferors 6 in solid oxide cell arrangements 1. Both the number and position of radiant heater elements 4 for heating up the solid oxide cell stack 3, as well as the number and position of heat transferors 6, as well as additionally the media supply and discharge on the electrode sides can vary, for example, can be split in the case of the media supply and discharge.

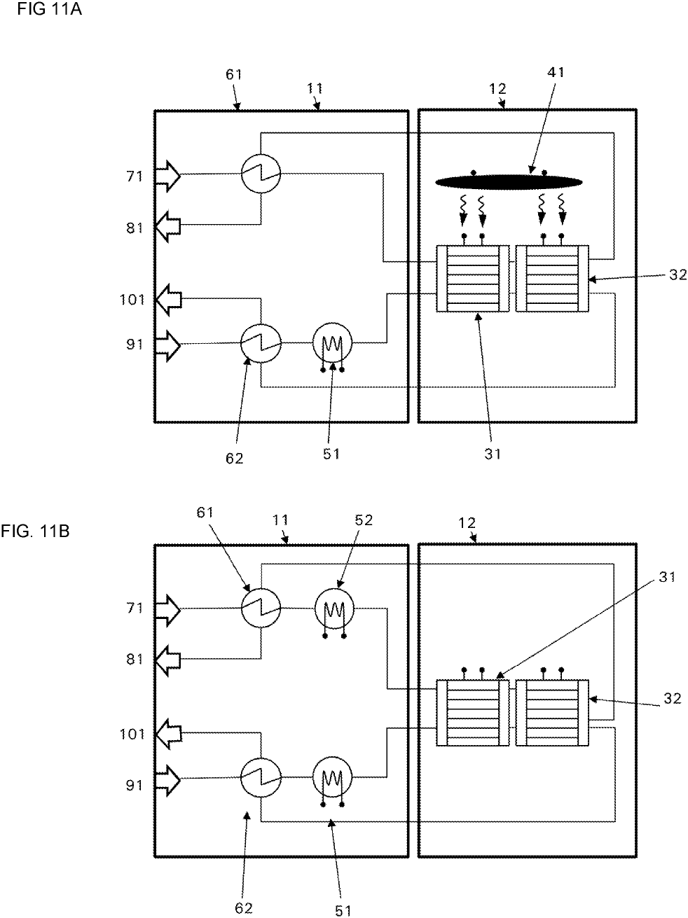

FIG. 11a illustrates a process diagram of a solid oxide cell arrangement with a radiant heater element 41, heat transferors 61, 62 arranged centrally in the gas processing unit 11, and an electric pre-heater 51. FIG. 11b illustrates a process diagram of a solid oxide cell arrangement with only conventional, electric pre-heaters 51, 52, and heat transferors 61, 62 arranged centrally in the gas processing unit 11.

It is evident from the two process diagrams how the technical plant structure for the operation of solid oxide cells changes when radiant heater elements 4 are used with central arrangement of the heat transferors 6.

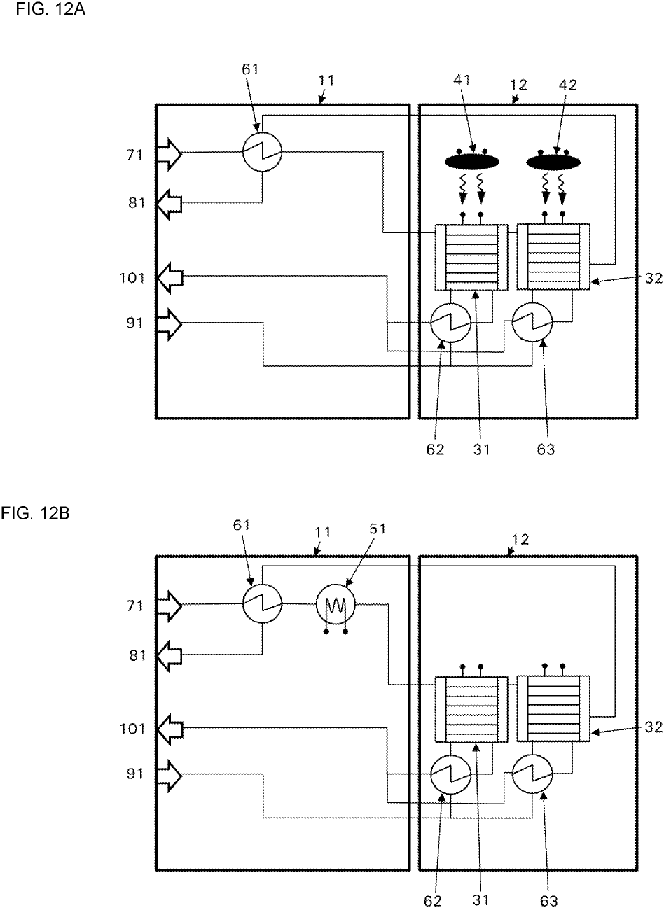

FIG. 12a illustrates a process diagram of a solid oxide cell arrangement 1 with two separate radiant heater elements 41, 42, heat transferors 61, 62 arranged decentrally in the cell stack module 12, and an electric pre-heater 51. FIG. 12b illustrates and a process diagram of a solid oxide cell arrangement with only conventional, electric pre-heaters 51, 52, and heat transferors 61, 62 arranged decentrally in the cell stack module 12.

It is evident from the two process diagrams how the technical plant structure for the operation of solid oxide cells changes when radiant heater elements 4 are used with decentral arrangement of the heat transferors 6.

The differences in the technical plant structure for the operation of solid oxide cells with central and decentral arrangement of the heat transferors 6 is evident from the comparison of FIGS. 11a-b and 12a-b.

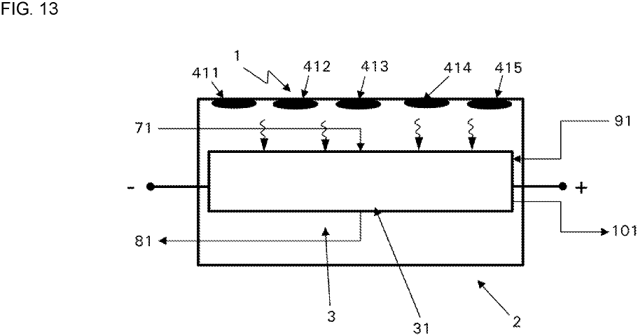

FIG. 13 shows a solid oxide cell arrangement 1 according to FIG. 1. Here, the radiant heater element 41 consists of a plurality of radiant heater segments 411, 412, 413, 414, 415.

### List of Reference Signs

1 Solid oxide cell arrangement 71 Media supply O2 electrode side 1
2 Housing 72 Media supply O2 electrode side 2
3 Solid oxide cell stack 73 Media supply O2 electrode side 3
31 Solid oxide cell stack 1 81 Media discharge O2 electrode side 1
32 Solid oxide cell stack 2 82 Media discharge O2 electrode side 2
33 Solid oxide cell stack 3 83 Media discharge O2 electrode side 3
34 Solid oxide cell stack 4 91 Media supply H2 electrode side 1
4 Radiant heater element 92 Media supply H2 electrode side 2
41 Radiant heater element 1 93 Media supply H2 electrode side 3
411 Segment 1 of radiant heater element 1 101 Media discharge H2 electrode side 1
412 Segment 2 of radiant heater element 1 102 Media discharge H2 electrode side 2
413 Segment 3 of radiant heater element 1 103 Media discharge H2 electrode side 3
414 Segment 4 of radiant heater element 1 11 Gas processing unit
415 Segment 5 of radiant heater element 1 12 Cell stack module
42 Radiant heater element 2
43 Radiant heater element 3
5 Convective, electric gas heater
51 Convective, electric gas heater 1
52 Convective, electric gas heater 2
6 Heat transferrer
61 Heat transferrer 1
62 Heat transferrer 2
63 Heat transferrer 3

1-7. (canceled)

8. A solid oxide cell assembly, comprising:
a housing including,
a base plate,
a cover, and
one or more side walls;
one or more solid oxide cell stacks positioned on the base plate; and
at least one radiant heater element positioned inside the housing and configured to emit radiant heat onto the one or more solid oxide cell stacks,
wherein the at least one radiant heater element is formed as one of a heating tube and a heating plate,
wherein the at least one radiant heater element comprises of a plurality of separately controllable segments each comprising separate power connections, and
wherein the solid oxide cell assembly is formed as a high temperature electrolysis cell assembly (SOEC).

9. The solid oxide cell assembly according to claim 8, wherein the one or more solid oxide cell stacks are disposed as a solid oxide cell stack series circuit comprising a plurality of rows adjacent to one another, and wherein one of the at least one radiant heater element is assigned for each solid oxide cell stack.

10. The solid oxide cell assembly according to claim 8, further comprising at least one heat transferor positioned in the housing.

11. The solid oxide cell assembly according to claim 8, further comprising at least one heat transferor positioned on a flange.

12. The solid oxide cell assembly according to claim 10, wherein an interaction between the at least one radiant heater element and the at least one heat transferor increases system efficiency.

13. The solid oxide cell assembly according to claim 8, wherein the at least one radiant heater element is integrated into one of the one or more side walls.

14. The solid oxide cell assembly according to claim 8, wherein the at least one radiant heater element is fixed to at least one of the one or more side walls and the base plate.

15. The solid oxide cell assembly according to claim 8, wherein the at least one radiant heater element is integrated into one or more ceramic plates.
